(19) United States
(12) Patent Application Publication
(10) Pub. No.: US 2012/0181258 A1
(43) Pub. Date: Jul. 19, 2012

(54) Apparatus and methods for transmission line based electric fence insulation

(76) Inventors: Xuekang SHAN, San Diego, CA (US); Jin Hao, San Diego, CA (US)

(21) Appl. No.: 13/009,840

(22) Filed: Jan. 19, 2011

(51) Int. Cl. H05B 1/02; H01B 17/16

(52) U.S. Cl. 219/200; 174/163 F

(57) ABSTRACT

Apparatus and methods for wire insulation in transmission line based electric fence are described in this invention. An insulator holds a wire pair that form the transmission line in its wire clamps. The insulator has a rain shed that sheds the wire clamps from getting wet by rain water. The insulator also has a pair of rain water divert guides that guide rain water accumulated on the wire to flow to the guide instead of to the wire clamps. This invention also describes a wire heating method that uses electric current to heat the fence wires such that the wire/wire clamp contact point will be kept dry and ice, snow accumulated on fence wires will be melted. Performance of the transmission line based electric fence can thus be greatly improved in advert weather conditions.

### BACKGROUND OF THE INVENTION

Electric fences are widely used for security purposes and for animal control. Most electric fences use metal wires to surround the area to be protected, and the metal wires are changed to a high voltage by energizers. When touched, this high voltage on the wires will repel or deter the intruder or animal. And an alarm signal is also triggered by the touch on the wire. But this type of electric fences can not give information of the location of the intrusion.

A recently filed patent application (application Ser. No. 12/954,704) describes a new type of electric fence, which is based on transmission line. A pair of metal wires are installed on the fence, which is equivalent to a common transmission line with a characteristic impedance. A short electric pulse is sent down the transmission line. If an intruder touches the transmission line, he adds a load impedance at this point of the line. According to the transmission line theory, a portion of the electric short pulse will be reflected back due to mismatched impedance. The intrusion can thus be detected and its location can be calculated from the time needed for the pulse to travel back.

Since the characteristic impedance is a function of the separation between the wire pair, a support element is needed every few meters to keep this separation constant. This is because changes in this separation lead to changes in local characteristic impedance, and hence pulse energy reflection. A practical fence has a length from a few hundred meters to tens of kilo meters. Therefore there will be hundreds or even thousands support elements alone the electric fence.

For the same reason as mentioned above, it is vital for the proper operation of this type of electric fence that the insulation between the wire pair and between the wire and ground at each support is kept at a high level, at least 4 orders higher than the characteristic impedance of the transmission line, since there are up to 1000 such supports along the whole electric fence, and more or less they all cause electric power leak between the wire pair of between the wire and the ground. The characteristic impedance of a wire pair transmission line is normally between 50 ohm and 1000 ohm, and therefore the insulation of each wire support needs to be 10 mega ohm or higher. In dry weather, this level of insulation is no problem at all if proper materials are used for the insulators, such as plastics, ceramic, glass, epoxy, or even wood. However, in non idea weather, such as rainy, snowy, foggy, or humid, days, to achieve such an insulation level becomes difficult. Dripping rain water, condensation, or dew, snow, ice, accumulated on surface, greatly reduce insulation resistance by orders. A reduction of insulation level means a load is connected between the wires or between the wires and the ground. This not only causes excessive pulse energy loss and hence reduced workable fence length, but also leads to scattered pulse energy reflection alone the fence, which either increases system background noise level, or increases false alarm rate. Therefore, transmission line based electric fences need significantly better insulators.

### SUMMARY OF THE INVENTION

This invention describes apparatus and methods to maintain high insulation level for transmission line based electric fence in advert weather conditions. The electric fence insulator described in this invention comprises two wire clamps, a rain shed, and two rain water divert guides. The clamp keeps the wire in place but allows it to move axially such that wire tension devices can apply tension to the wire. The rain shed sheds the wire clamp such that rain drops will not hit the wire/wire clamp contact point. The rain water divert guide is a plastic string, attached to the wire on both sides of the clamp, with a dip at the middle. When rain water accumulates on the wire, it may flow towards the wire clamp due to the not level installation of the wire, and thus may wet the wire/wire clamp contact point. The rain water divert guide directs the rain water toward the string dip, and thus keeps the wire/clamp contact point from rain water.

In the transmission line based electric fence there is a possible electric current loop. This invention uses this electric current loop to heat the wire or wire pair, particularly to heat the wire/wire clamp contact point. This is accomplished naturally, since the wire clamp holds the wire and thus prevents heat from radiating into air. The raised temperature at the wire/wire clamp contact point evaporates water condensation. This electric current also melts possible ice run or snow accumulated on the wires. The amount of the electric current needed to do this can be controlled manually, or by an automatic control loop.

### DETAILED DESCRIPTION OF FIGURES

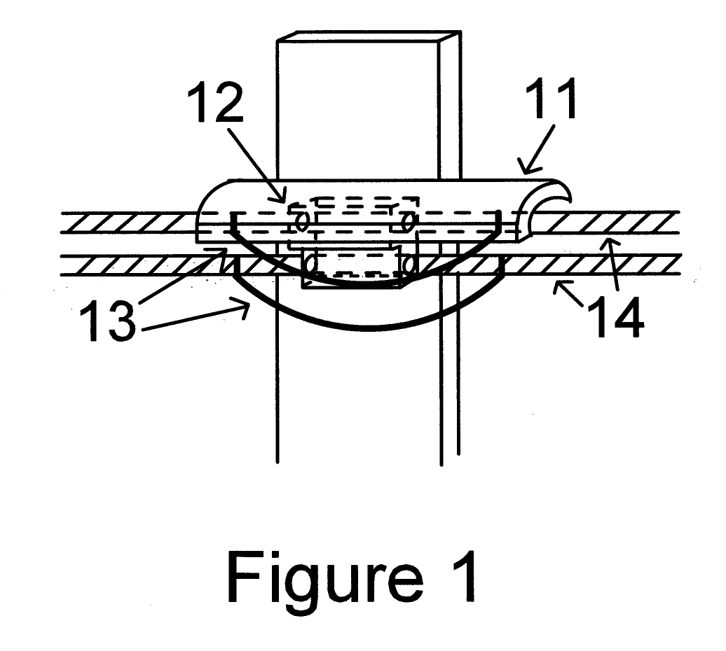

FIG. 1 is a perspective view of the insulator of this invention. Rain shed 11 sheds wire clamps 12. Wire clamps 12 clamp wire pair 14. Rain water divert guides 13 prevent rain water from flowing into the wire/wire clamp contact points.

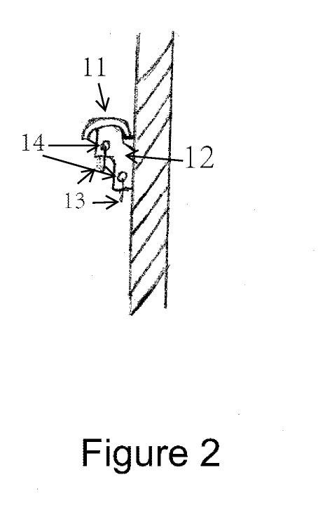

FIG. 2 is a side elevation showing the horizontal offset between the two wires to prevent short circuit by rain water dripping or by ice run.

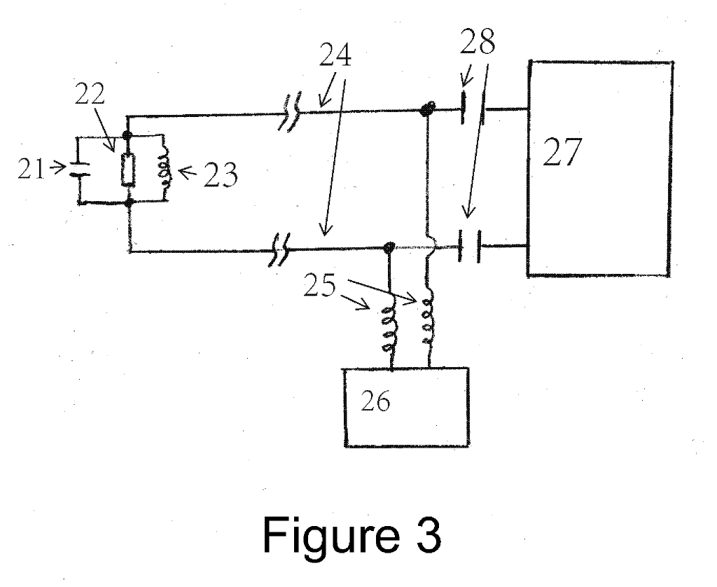

FIG. 3 shows a method for heating the transmission line by electric current. Heating power supply 26 is a DC or low frequency AC power source, that supply an electric current to wire pair 24 via a pair of inductors 25. These inductors have low impedance for DC or low frequency AC current, but have high impedance for high frequency short pulse generated by Transmitter 27. Capacitors 27 blocks the DC or low frequency AC current from flowing into the Transmitter, but allow for high frequency short pulses to pass through. Inductor 23, capacitor 21 and resistor 22 form a resonator that exhibits an impedance identical to the transmission line's characteristic impedance to the high frequency short pulse, but has a low impedance for the heating current.

### DETAILED DESCRIPTION OF THE PREFERRED EMBODIMENTS

FIG. 1 shows the insulator of this invention. The insulator is mounted on the post via holes and bolts. The wire pair are attached to the insulator by clamps and bolts. The two wires have an offset horizontally such that rain water will not drip into a continuous line between the two wires to form a resistive load between the wire pair. When rain water collected on the wire flows towards the wire clamp, the rain water divert guide guides the water to the bottom of the guide and keeps it from wetting the wire/wire clamp contact point.

A DC or a low frequency AC power source is used to heat the transmission line when necessary. The transmission line based electric fence works using high frequency short electric pulses. Therefore low-pass and high-pass electric filters that have different impedance at different frequencies can be used to supply electric current to heat the wires without affecting the normal operation of the electric fence. In FIG. 3, inductor 23, capacitor 21, and resistor 22 form a parallel resonator that exhibits the transmission line characteristic impedance at the pulse train frequency while providing a low impedance path for a DC or low frequency AC current to heat the wire pair. The amplitude of this current can be controlled manually via a variable resistor, or can be controlled by an automatic controller.

1. an insulator for electric fence comprising
a. wire clamps that hold wire in position while allowing the wire to move axially;
b. a rain shed which keep rain water from wetting said wire clamps;
c. a rain water divert guide that deflects rain water such that it will not flow towards and wet said wire clamps;

2. an electric heating system for use in conjunction with said insulator that sends electric current through electric fence wires;
a. Said electric current may be direct current (DC) or alternative current (AC).
b. said electric current is supplied to transmission line via low pass filters that have high impedance at higher frequencies but exhibit lower impedance at lower frequencies or direct current.
c. amplitude of said electric current may be controlled manually or by an automatic controller.
